(19) United States
(12) Patent Application Publication
(10) Pub. No.: US 2005/0269854 A1
(43) Pub. Date: Dec. 8, 2005

(54) Vehicle seat latch assembly having a pivoting anti-chuck hook for engaging a floor-mounted striker plate

(76) Inventors: Tavis Lutzka, Clawson, MI (US); Harry Keith Brantley, Utica, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/859,686

(22) Filed: Jun. 3, 2004

(51) Int. Cl. E05B 15/02; B60N 2/02; B60N 2/48

(52) U.S. Cl. 297/378.13

(57) ABSTRACT

A latch assembly for use with a vehicle seat pivotally mounted to a vehicle floor and which engages a striker associated with the vehicle floor. A planar shaped support bracket secures to an underside location of the seat. A first latching member pivotally mounts to the planar support bracket and exhibits an edge defined recess. A second latching member pivotally mounts to the planar support bracket, in overlapping relationship relative to the first latching member, and exhibits a second edge defined recess opposing the first recess. The first and second latching members define a first engaged position by which the striker bar is seated therebetween. A linkage member is secured to each of the latching members and is actuated causing the first latching member to pivot in a first unseating direction relative to the striker, the second latching member is caused to pivot in an opposite unseating direction and to disengage the striker from the vehicle seat in a second disengaged position.

### BACKGROUND OF THE INVENTION

1. Field of the Invention

The present invention relates generally to latch assemblies, particularly in use with a pivoting vehicle seat. More particularly, the present invention discloses an improved latch assembly, secured to an underside location of a pivotally mounted seat and which is selectively engageable with a floor-mounted striker plate. Upon being released from engagement with the striker plate, the seat is permitted to rotate to a forward dump position.

2. Description of the Prior Art

The prior art is well documented with examples of latch mechanisms, and such as which are particularly useful in selectively engaging and releasing a vehicle seat from an associated floor location of the vehicle. Such seat latch mechanisms are specifically intended, upon being disengaged, to facilitate forward pivoting, or dumping, motion of such as a rearward row of vehicle seats.

U.S. Pat. No. 6,412,849, issued to Fast, teaches a latch assembly adapted for use in a vehicle having a movable member, a fixed member, and a striker fixed to one of the movable and fixed members. The latch assembly is adapted to be connectable to the other of the movable and fixed members and to selectively couple the movable member to the striker.

The latch assembly further includes a housing, a latch and a release cam coupled to the housing, a spring, and a release mechanism. The housing includes a striker opening adapted to accommodate the striker. The latch is operable in a latched position when the latch assembly is in a latched mode wherein the latch is adapted to couple the striker to the housing and in an unlatched position when the latch assembly is in an unlatched mode and wherein the striker is freely movable relative to the housing.

The release cam is operable in an engaged position to urge the latch toward its latched position and in a released position to its unlatched position. The spring urges the release cam towards its engaged position and the latch towards its unlatched position. Finally, the release mechanism is operable for selectively moving the release cam from its engaged position to its released position.

U.S. Pat. No. 5,730,480, issued to Takamura, teaches a lock device with a striker and lock proper. The lock proper includes a base member having a striker receiving slot into which the striker can be led. A latch plate is pivotally connected to the base member. A locking plate is pivotally connected to the base member and a striker restraining member is pivotally connected though a pivot shaft to the base member. The striker restraining member is pivotal between a restraining position, where a contact edge thereof abuts against the striker, and a releasing position, where the contact edge disengages from the striker.

Springs are employed for biasing the latch plate to pivot toward a standby position, biasing the locking plate to pivot toward a lock position, and biasing the striker restraining member to pivot towards the restraining position. A link mechanism is employed for causing the striker restraining member to take the restraining position when the latch plate and the locking plate take latching and lock positions respectively. The pivot shaft of the striker restraining member is positioned at the back of the striker receiving slot, so that the contact edge of the striker restraining member can abut against a front side of the striker.

U.S. Pat. No. 6,039,401, issued to Rus, teaches a latch mechanism removably attached to a front portion of a collapsible and removable utility seat assembly to a latch rod on a vehicle floor pan. The latch mechanism includes a bracket adapted for attachment to the front portion of the utility seat assembly with a wheel attached thereto. The latch mechanism also includes a locking mechanism connected to the bracket. The locking mechanism includes a lock member rotatably connected to the bracket and adapted for engagement with the floor pan for causing rotation of the lock member with respect to the bracket to facilitate locking of the locking mechanism onto the latch rod as the utility seat assembly is collapsed.

U.S. Pat. No. 6,213,525, issued to Nicola, teaches a lever action floor latch actuation mechanism for removably securing a seat to a pair of front and rear strikers located on the floor of a vehicle. A riser having a forward leg and a rearward leg supports the seat above the vehicle floor. Front and rear latches are pivotally connected to the forward and rearward legs, respectively, for releasably securing the seat to the strikers. A longitudinal link pivotally interconnects the front and rear latches and an actuation member coupled to the link simultaneously moves the latches between a latched position engaging the strikers and an unlatched position disengaging the strikers.

Each latch includes a cinch cam pivotally connecting the latch to the riser, the cinch cam exhibiting a cylindrical outer surface terminating at a flattened cam surface. A spacer plate is fixedly secured between the latch and the riser and includes a center aperture for rotatably receiving the cinch cam. The aperture forms a circular section and a tangential slot for seating the flexible plate. The cylindrical surface of the cam engages and flexes the plate when the latch is pivoted to the latched position providing an anti-rattle biasing force between the latch and striker and the flattened surface releases the flex in the plate when the latch is pivoted to the unlatched position disengaged from the striker.

U.S. Pat. No. 5,951,086, issued to Hoshino, discloses a detaching mechanism for a vehicle seat which includes a latch claw installed on a fixed rail of a back and forth slide mechanism, as well as a lock release knob disposed between the latch claw and an operating lever for a lock release operation supported by a movable rail. An end portion of the operating lever is inserted into an inside of the back and forth slide mechanism from a through hole formed in the movable rail. The lock release knob is operated by the operating lever and an engagement between a striker disposed on a vehicle floor and the latch claw is released.

Finally, U.S. Pat. No. 4,773,693, issued to Premji et al., teaches a seat release mechanism adapted to cooperate with two generally parallel spaced mounting bars rigidly affixed to a vehicle frame forming part of the vehicle body. The latching assembly includes a bridge plate adapted for rigid attachment to the vehicle seat and dimensioned to span the distance separating a first and second of the mounting bars.

The bridge plate includes a first connecting slot for releasable securing engagement with the first mounting bar and a second connecting mechanism for releasable securing engagement with the second mounting bar. The first connecting means includes an open-ended slot formed in the bridge plate and which is adapted for surrounding engagement with the first mounting bar so as to permit pivotal movement of the bridge plate and the attached vehicle seat about the first mounting bar.

The second connecting mechanism includes a pair of opposed movable jaw members pivotally mounted on the bridge plate for independent pivotal movement between a latchable configuration in which the jaw members are adapted to enclose the second mounting bar so as to restrain pivotal movement of the seat and an unlatchable configuration in which the jaw members are adapted to open from such enclosure so as to release the second mounting bar. The vehicle seat can thus pivot about the first mounting bar for subsequent removal only when the jaw members release the second mounting bar.

### SUMMARY OF THE PRESENT INVENTION

The present invention is an improved latch assembly for use with a vehicle seat pivotally mounted to a vehicle floor. In particular, the latch assembly is an improvement over prior art assemblies in that it provides fixedly support brackets secured to the underside of the vehicle seat in combination with opposing and pivotally engaging latching plates for securely engaging a crosswise extending striker bar in secure and anti-chuck (non-vibrating) fashion. Upon disengagement from the striker, the seat is permitted to rotate about a forward pivot location to a forward dumped position.

In a preferred embodiment, first and second brackets are secured to the seat underside and in spaced-apart fashion. A first latch plate is secured in pivotal and sandwiching fashion, such as by a mounting collar, between the first and second brackets. The latch plate includes a first side edge disposed aperture. A cam is likewise pivotally mounted between the support brackets and defines a shoulder upon which is supported the lateral projecting location in an engaged position.

A second latch plate, defined as an anti-chuck plate, is secured in likewise pivotal fashion upon an exposed face of the second support bracket. The anti-chuck plate includes a second side edge disposed recess, substantially overlaying said first edge recess, and between which seats the striker in the engaged position.

A linkage member secures to each of the latch plate, anti-chuck plate, and cam. A first fastener seats through an arcuate slot defined along the linkage member and secures to a location of the anti-chuck plate offset from its pivot point. A second fastener extends from a further location of said linkage member, to the cam, and in order to pivotally associate the cam relative to a further fixed pivot collar extending between the brackets. A coil spring extends from a yet further location of the linkage member and secures to a generally uppermost location of the latch plate to likewise pivotally associate the latch plate relative to its mounting location with the plates.

In use, the linkage member is slidably translated, causing the anti-chuck plate to pivot in an unseating traveling direction consistent with the arcuate slot defined in the linkage member. Concurrently, the cam is pivoted by virtue of its connection to the linkage member and resultant tension on the coil spring causes the latch plate, by virtue of its configuration, to rotate in an opposite direction relative to the cam and so that the shoulder and projecting portion are unseated and the latch plate permitted to rotate to an opposite unseating direction to fully disengage the latch assembly from the striker bar.

A first end of a translating coil is secured to an end of the linkage member, a second opposite end attaching to a handle associated with the vehicle seat. In a preferred application, the handle is actuated to pivotally fold the seat back relative to the seat bottom in combination with permitting the seat to rotate to the forward dump position.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first environmental view of the vehicle floor latch assembly in a fully engaged position;

FIG. 2 is a succeeding environmental view illustrating a seat back in a forwardly rotated position and the vehicle floor latch assembly in a partially disengaged position;

FIG. 3 is a further succeeding environmental view illustrating the vehicle floor latch assembly in a fully disengaged position;

FIG. 4 is an exploded view illustrating the several components associated with the vehicle floor latch assembly according to the present invention;

FIG. 5 is a perspective and assembled view of the floor latch assembly illustrated in FIG. 4;

FIG. 6 is an enlarged view of the floor latch assembly in a fully engaged position about the striker plate and corresponding substantially to the environmental view of FIG. 1, as well as the perspective view of FIG. 5;

FIG. 7 is a succeeding illustration of the floor latch assembly in a partially disengaged position about the striker plate and corresponding substantially to the environmental view of FIG. 2; and

FIG. 8 is a further succeeding illustration of the floor latch assembly in a fully disengaged position relative to the striker plate and corresponding substantially to the environmental view of FIG. 3.

### DETAILED DESCRIPTION OF THE PREFERRED EMBODIMENT

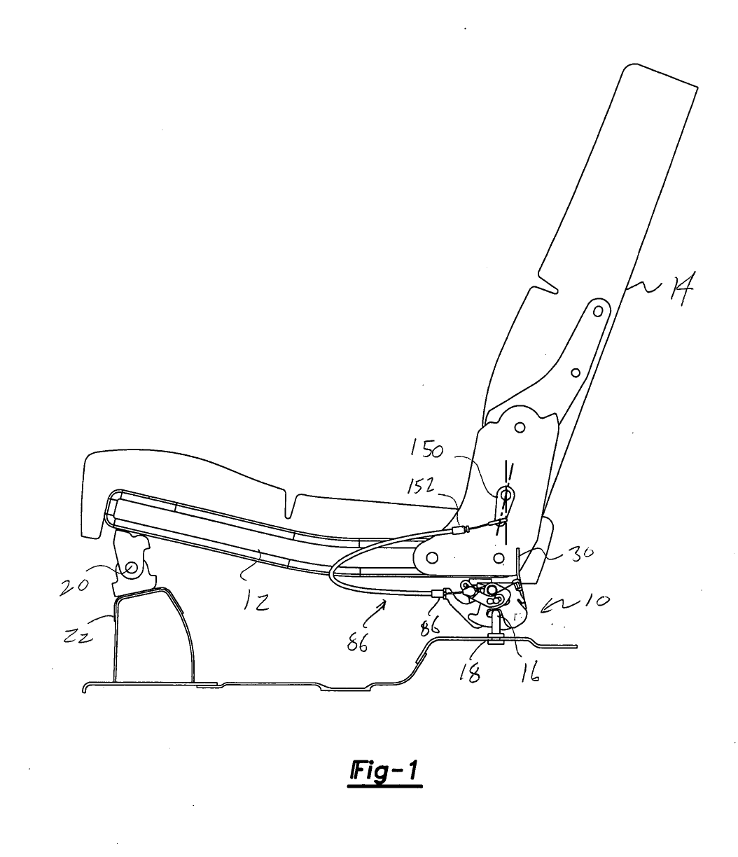

Referring now to each of FIGS. 1-8, a latch assembly is illustrated at 10 in use with a vehicle seat according to the present invention. As best illustrated in the succeeding environmental illustrations of FIGS. 1-3, the seat includes (in relevant part) a bottom 12 and a pivotally associated seat back 14.

As is also known, the latch assembly 10 engages a striker assembly, typically including a substantially U-shaped member secured to the vehicle floor and in particular exhibiting a crosswise extending member 16 arrayed in proximity to a floor location 18 typically associated with a rear end of the seat bottom. The seat bottom 12 is also mounted, in pivoting fashion, at 20, atop a further and forwardly disposed floor mounting location 22 associated with the seat and such that, as illustrated again by the environmental views of FIGS. 1-3, permits the seat back 14 to be folded against the seat bottom 12, during sequential disengagement of the latching assembly 10 from the striker 16, following which the seat is rotated forwardly to a dump position.

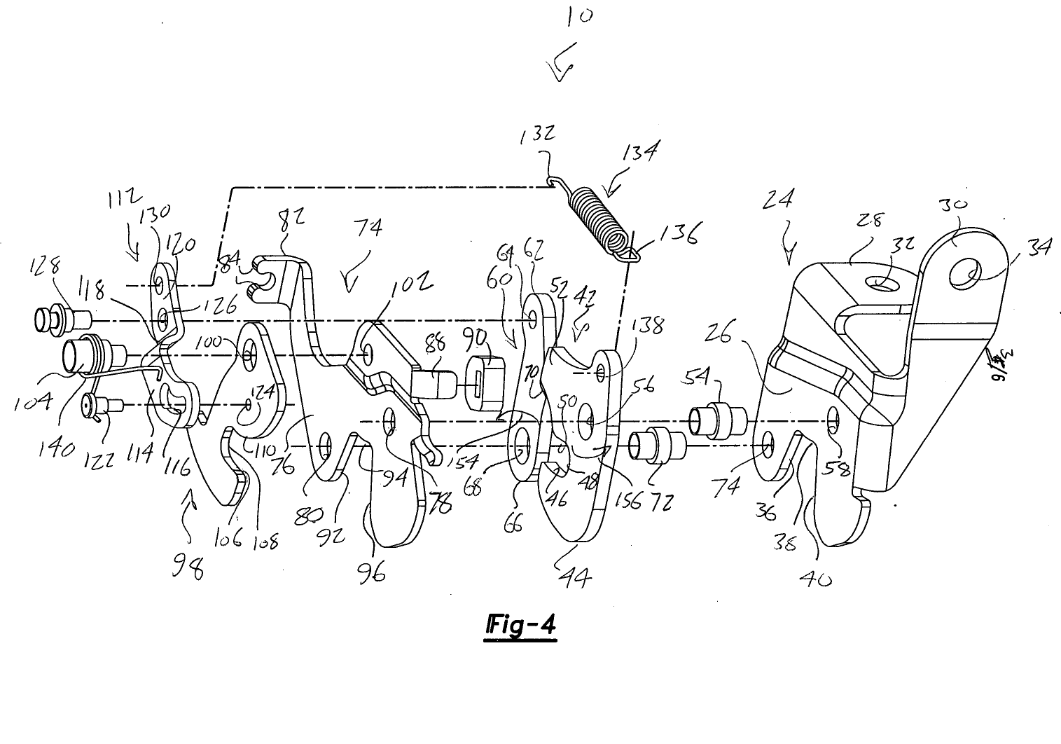

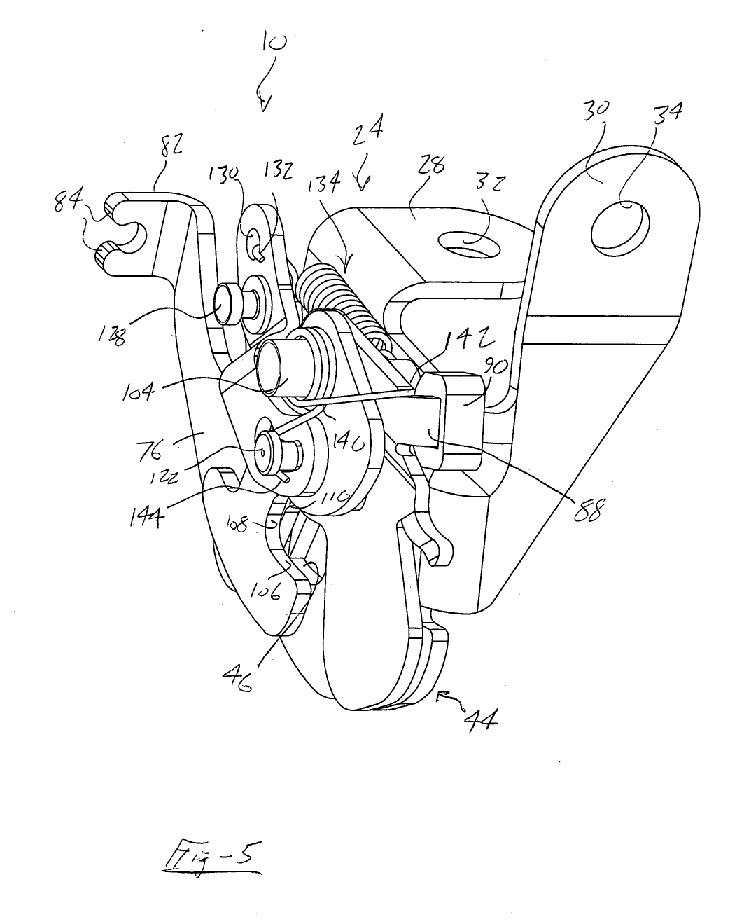

A first bracket, illustrated generally at 24 and as is best shown in FIGS. 4 and 5, includes a substantially planar face 26, a first angularly disposed mounting location 28 and a second angularly disposed mounting location 30. Apertures are typically formed through the mounting locations, see further at 32 and 34, respectively, and by which the bracket 24 is bolted in downwardly extending location to the frame associated with the seat bottom 12 and further such that the substantially planar face 26 is arrayed with the striker 16 extending in crosswise fashion. The bracket 24 further includes inwardly directed bottom edge surfaces, see at 36, 38 and 40 in FIG. 4, and which in combination define a recessed bottom location adequately dimensioned for seating therebetween the striker 16.

A latch plate, see as generally illustrated at 42 in FIG. 4, includes a planar shaped and configured body exhibiting in particular a rounded bottom edge 44, inwardly configured side edges 46, 48 and 50 which define in combination a side extending edge recess, and a lateral projection 52 extending from above the side edge recess. The latch plate 42 is pivotally secured to a selected face of the first bracket 24 by virtue of a mounting and spacing collar 54 which seats through apertures associated with the latch plate 42, at 56, as well as with the substantially planar face 26 of the bracket 42, see further at 58.

A cam 60 includes an elongated and likewise substantially planar shaped body exhibiting a rounded upper edge 62 (through which is formed a first aperture 64), a rounded lower edge 66 (through which is formed a second aperture 68) and a sideways extending shoulder 70. The cam is pivotally mounted through aperture 66, by a spacer collar 72 in turn interconnected to aperture 74 defined in the first bracket 24, and in such a manner that the shoulder 70 supports a lower surface of the lateral projecting location 52 in an engaged position.

A second planar shaped and support bracket is generally illustrated at 74 (see again as best shown in FIG. 4) and includes a substantially planar face 76. The second bracket 72 is mounted in spaced relationship with the first bracket 24, by virtue of apertures 78 and 80 defined in the planar 74 and which receive inserting ends of the spacer collars 54 and 72, respectively, and in order to mount the latch plate 42 and cam 60 in sandwiching fashion.

The second support bracket 72 further includes an angled portion 82, exhibiting end tabs 84, and for mounting an associated end of a translating cable 86, as will be subsequently described in additional detail. A further angular (typically 90° bent) projection 88, illustrated in an opposite facing direction from the angled portion 82, seats thereupon a rubberized and crosswise extending bumper 90, and which defines an abutment stop for unseating pivoting of the latch plate 42 as will also be subsequently described. The second support bracket 74 further includes inwardly directed bottom edge surfaces, see at 92, 94 and 96 in FIG. 4, and which in combination define a recessed bottom location aligning substantially with that defined by bottom edge surfaces 36, 38 and 40 associated with the first bracket 24, and again adequately dimensioned for seating therebetween the striker 16.

A further linkage member, defined also as an anti-chuck plate (see at 98 in FIG. 4), exhibits a substantially smooth edged and planar shaped body. The anti-chuck plate 98 exhibits a generally upper end aperture 100, positioned in alignment with an upper end aperture 102 defined in the face 76 of the second bracket 74, and in such that a collar 104 inserts therethrough to secure the plate 98 in pivotal fashion upon the exposed face 76 of the second bracket.

A recess is defined in a side extending edge surface of the anti-chuck plate 98, see as defined by inwardly directed surfaces 106, 108 and 110, and which are arranged in opposing and overlapping relationship relative to the first recess defined in the latch plate 42 (see again inwardly directed surfaces 36, 38 and 40). As best illustrated in FIGS. 5-8, the second recess is also in selective communication with the bottom edge recesses defined in each of the first 24 and second 74 planar brackets and, in an engaged position, the anti-chuck plate 74 engages the striker 16 in opposing fashion with the latch plate 42.

A linkage member is referenced generally at 112 (see again as best shown in FIG. 4) and includes an elongated body further defined by a first substantially planar shaped portion 114, through which is configured an arcuate shaped slot 116. A second, three-dimensionally offset (see angled portion 118) and planar shaped portion 120 extends in interconnecting fashion from the first portion 114.

The linkage member 112 is secured to each of the latch plate 42, the anti-chuck plate 98, and the cam 60. A fastener 122 inserts through the arcuate and channeled aperture 116 defined in the first planar shaped portion 114 and seats within an aligning aperture 124 defined in a substantially interior location of the planar shaped body associated with the anti-chuck plate 98.

An aperture 126, defined through the second offset and planar shaped portion 120, receives an additional pin fastener, see at 128, in inserting fashion, an extending end of the pin fastener 128 securing the upper end aperture 64 of the cam 60. A yet further aperture 130 is located at a generally uppermost end location of the linkage mechanism 112 and receives a first end 132 of a coil spring, see as further generally shown at 134.

A second extending end 136 of said coil spring 134 engages an upper edge apertured location (see at 138 in FIG. 4) of the latch plate 42, and which is offset from its associated pivot point 56 and lateral projection 52. A secondary coil spring 140 biasingly influences the anti-chuck plate in an engaging rotational direction relative to the striker 16. This is accomplished through a first tang end 142 of the spring 140 engaging an upper edge location of the second bracket 74. An opposite second tang end 144 is curled to seat around an enlarged head of pin fastener 122, again seated within the arcuate channel 116, and in order to bias the anti-chuck plate 98 against the striker 16 in the engaged position.

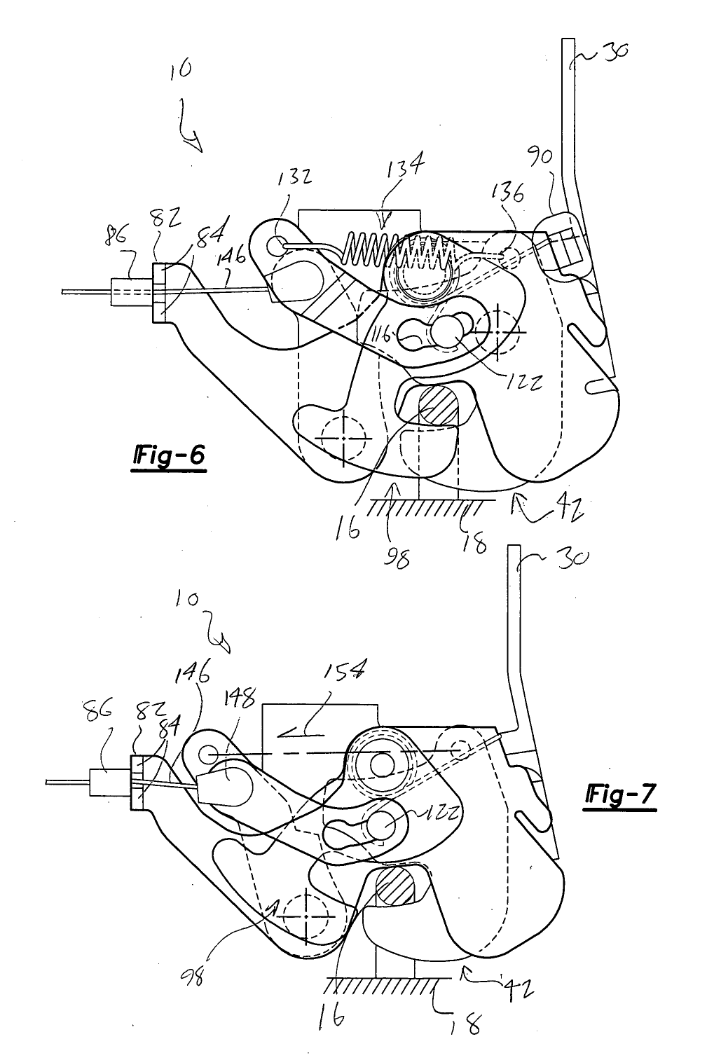

Referencing plan view illustrations of FIGS. 6-8 respectively in relation to the environmental views 1-3, an explanation of the disengagement protocol for the latch assembly 10 will now be made. The translating cable 86 is again mounted to the end tabs 84 of angled portion 82 of the second bracket 74 and includes an inner filament 146 (typically an inner wire) mounting, at a cap end 148 of the filament, and which is in turn secured over the head associated with pin fastener 128 mounted to the linkage mechanism 112.

As is known, the inner filament 146 is translatable relative to the outer fixed cable sheath 86, in turn actuated by a handle 150 pivotally associated with the seat bottom 12 and seat back 14 (see FIGS. 1-3). As previously described, actuation of the handle 150 in a preferred embodiment causes the seat back 14 to pivot forwardly relative to the seat bottom 12 and upon the latch assembly being disengaged, and in order to pivot the seat to a forwardly dumped position.

Referring to FIGS. 1 and 6 in combination, the latch assembly is illustrated in substantially engaged position about the striker 16, and with the anti-chuck plate 98 and latch plate 42 arrayed on opposite, and inwardly biasing sides, of the striker 16. Biasing engagement of the striker is facilitated by the application of the biasing force introduced through the secondary coil spring 140, against the anti-chuck plate 98, as well as shoulder abutting support of the cam 60 (see also at 70 in FIG. 4) against the projecting location 52 of the latch plate 42.

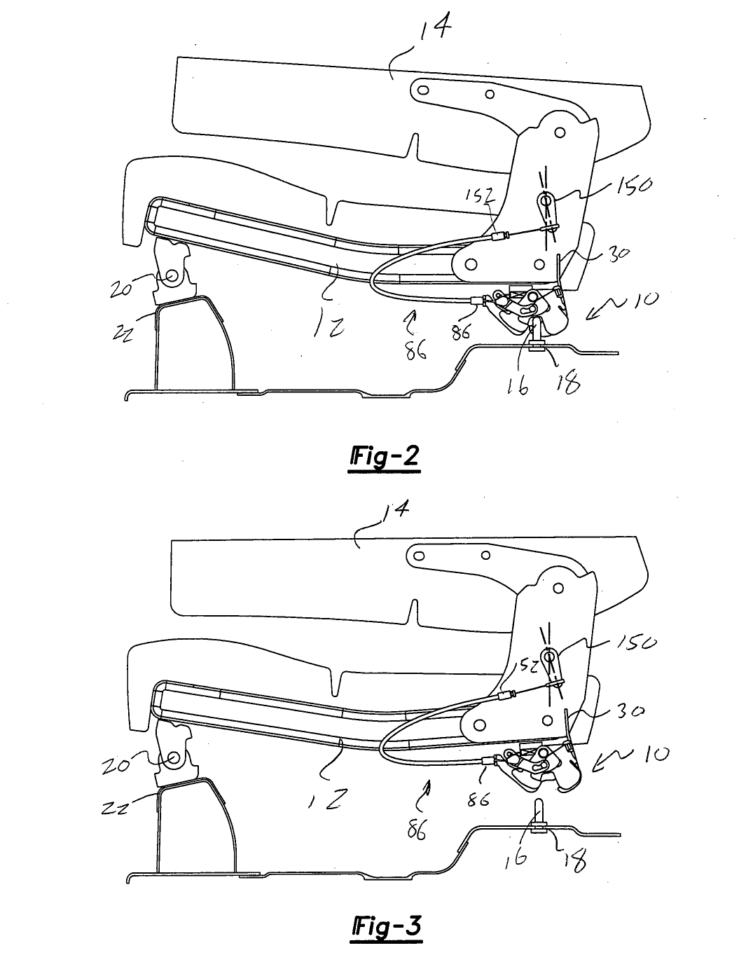

Referring further to FIGS. 2 and 7, an intermediate disengagement condition of the latch assembly 10 is created by the actuation of the linkage member through rotation of the seat handle 150, and commensurate translation of the inner filament 146 (the sleeve 86 also connecting to the handle 150 at location 152). Translation of the cable filament 146 causes the linkage member 112 to translate, in direction 154 shown in FIG. 7.

In turn, the anti-chuck plate 98 is caused to pivot in an unseating direction relative to the striker 16 and the bottom recesses defined in the first 24 and second 74 aligning brackets and to the position illustrated in FIG. 7, wherein the plate 98 is substantially withdrawn from the aligning bottom edge recesses in the brackets. The illustration of FIG. 7 illustrates the latch plate 42 in remaining engaging contact against the striker 16.

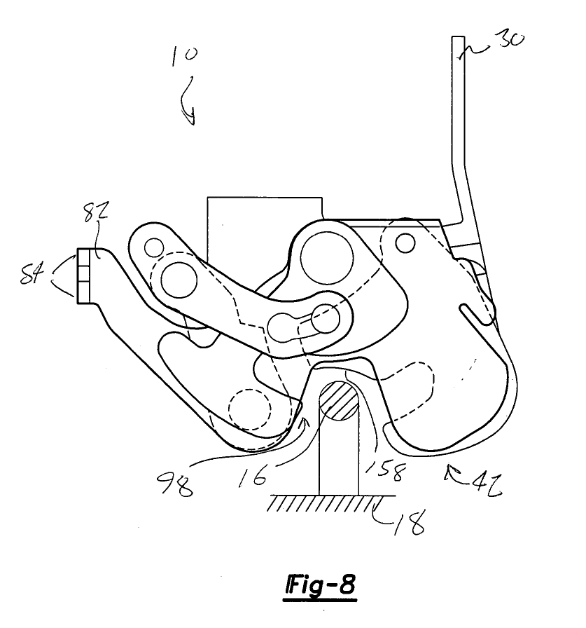

Referring finally to FIGS. 3 and 8, in combination, unseating of the latch plate 42 occurs from both the striker 16 and the aligning bottom edge bracket recesses, as well as in an opposite unseating direction relative to the anti-chuck plate 98. Unseating of the latch plate 42 is caused by the combined effects of the cam 60 pivoting, in a direction 154 referenced in FIG. 4, about its pivot location 68, simultaneously with tension created in the coil spring 134 (from linkage mechanism mounted end 132 and applied to opposite spring end 136 secured to location 138 of latch plate 42).

In this fashion, the latch plate 42 pivots in a direction 156 (see again FIG. 4) concurrent with the generally opposite pivoting motion of the cam 60 (again about arcuate arrow direction 154) and which occurs upon the lateral projection 52 of the latch plate unseating from the cam 60 resultant from its shoulder 70 first being rotated away from contact with the projection 52. At this point, and referring back to FIG. 3, the seat is released from the striker 16 and permitted to forwardly pivot (or dump) about seat pivot location 20.

Although not clearly shown, a reengagement protocol includes the step of downward reengagement of the striker 16, between the bracket bottom edge recesses. At this point, exposed surface 158 (see FIG. 8) of the latch plate 42 is contacted by the striker 16, this causing the latch plate to 42 rotate in a reverse and reengaging direction relative to the striker. Reverse tension applied to coil spring 134 (from latch plate mounted end 136 to linkage mechanism mounted end 132), in turn causes the linkage mechanism to translate in a reverse direction (to that illustrated previously by arrow 154 in FIG. 7) and such that the anti-chuck plate 98 is reengaged in opposing fashion relative to the latch plate 42 and about the striker 16.

It is also understood that a number of the reference numerals exhaustively presented in FIG. 4 (and to a lesser extent in FIG. 5) have been omitted from the actuation views of FIGS. 6-8 and this is understood to occur for purposes of ease of clarity and presentation. Additionally, the manner in which the latch plate and anti-chuck plate secure the striker from opposing sides assists in establishing a secure, anti-chucking, engagement about the striker and which enhances the quality perception of the assembly. Furthermore, the fixed nature of the underside brackets 24 and 74, relative to the striker 16, is compensated by the sizable bottom edge recesses formed in the brackets, combined with the adequate spacing provided in the opposing and recessed side edges of the latch and anti-chuck plates.

Having described my invention, other and additional preferred embodiments will become apparent to those skilled in the art to which it pertains, and without deviating from the scope of the appended claims.

1. A latch assembly for use with a vehicle seat pivotally mounted to a vehicle floor, said latch assembly engaging a conventional striker bar associated with the vehicle floor, said latch assembly comprising:
at least one planar shaped support secured to an underside location of the seat, a bottom edge surface of said support exhibiting a recess within which seats the striker bar in crosswise extending fashion and upon the seat being established in an engaged position upon the vehicle floor;
a latch plate pivotally mounted to said planar support and exhibiting a first recess in a side extending edge surface which is in selective communication with said bottom edge recess;
an anti-chuck plate pivotally mounted to said planar support in overlapping relationship relative to said latch plate, said anti-chuck plate exhibiting a second recess in a side extending edge surface arranged in opposing and overlapping relationship relative to said first recess, said second recess being in selective communication with said bottom edge recess of said planar shaped support; and
a linkage member secured to each of said latch plate and said anti-chuck plate, actuation of said linkage member causing said latch plate to pivot in an unseating direction relative to said bottom edge recess of said planar support portion, said anti-chuck plate being caused to pivot in an opposite unseating direction relative to said bottom recess and to disengage the striker bar.

2. The latch assembly as described in claim 1, further comprising first and second planar shaped supports, said latch plate pivotally securing between said planar supports, said anti-chuck plate being pivotally secured upon an exposed face of said second planar shaped support.

3. The latch assembly as described in claim 2, said latch plate exhibiting a lateral projection, a cam pivotally mounting between said planar supports and defining a shoulder upon which is supporting said lateral projecting location in an engaged position.

4. The latch assembly as described in claim 3, said linkage member further comprising an elongated body exhibiting an arcuate shaped slot along a specified axial length, a fastener seating through said arcuate slot and securing to said anti-chuck plate at a location offset from its associated pivot point.

5. The latch assembly as described in claim 4, further comprising a fastener extending from a further location of said linkage member, an extending end of said fastener engaging a location of said cam offset from its pivot point, actuation of said linkage member causing said cam to pivot and its shoulder to unseat from said latching plate.

6. The latch assembly as described in claim 5, further comprising a coil spring securing at a first end to a generally uppermost location associated with said linkage mechanism, a second extending end of said coil spring engaging a location of said latch plate offset from its associated pivot point and lateral projection.

7. The latch assembly as described in claim 6, further comprising a secondary coil spring biasingly influencing said anti-chuck plate in an engaging rotational direction relative to the striker bar.

8. The latch assembly as described in claim 3, said first planar shaped support including first and second mounting locations for fixedly securing to underside location of the seat.

9. The latch assembly as described in claim 8, said second planar shaped support bolting to said fixed planar shaped support at locations defining said pivotal arrangement of said latching plate and said cam sandwiched therebetween, said second planar shaped support securing a fixed extending end of a flexible outer sleeve, an inner filament associated with said sleeve extending therefrom and securing to said linkage member.

10. The latch assembly as described in claim 9, the seat including a seat back pivotally secured to a seat bottom, said latch assembly further comprising an opposite extending end of said translating cable securing to a handle operable to engage said inner translating coil.

11. The latch assembly as described in claim 10, the seat further including a pivotal mounting location proximate a forward end of the seat bottom, said handle actuating to pivotally fold the seat back relative to the seat bottom in combination with permitting said seat to rotate to a forward dump position.

12. The latch assembly as described in claim 9, further comprising a rubberized crosswise extending bumper extending from an edge location of a selected planar shaped support and defining an end abutment stop to said latch plate upon being rotated in said unseating direction.

13. The latch assembly as described in claim 6, said elongated linkage member further comprising a first substantially planar shaped portion through which is configured said arcuate shaped slot, a second three-dimensionally offset and planar shaped portion extending in interconnecting fashion from said first portion and to which is engaged said fastener and said coil spring.

14. A latch assembly for use with a vehicle seat pivotally mounted to a vehicle floor, said latch assembly engaging a conventional striker bar associated with the vehicle floor, said latch assembly comprising:
a planar shaped support bracket secured to an underside location of the seat;
a first latching member pivotally mounted to said planar support bracket and exhibiting an edge defined first recess;
a second latching member pivotally mounted to said planar support bracket, in at least partially overlapping relationship relative to first latching member, and exhibiting a second edge defined recess arranged in opposing relationship relative to said first recess, said first and second latching members defining a first engaged position by which the striker bar is seated therebetween; and
a linkage member secured to each of said latching members, actuation of said linkage member causing said first latching member to pivot in a first unseating direction relative to the striker bar, said second latching member being caused to pivot in an opposite unseating direction and to disengage the striker bar from the vehicle seat in a second disengaged position.

15. The latch assembly as described in claim 14, further comprising a pin rotatably securing said first latching member and seating through an arcuate shaped slot defined in said linkage member, a spring interconnecting said second linkage member.

16. The latch assembly as described in claim 15, a cam pivotally mounting in selectively contacting fashion with said second latching member, said cam defining a shoulder upon which is supported a lateral projection associated with said second latching member in an engaged position.

17. The latch assembly as described in claim 16, further comprising a secondary coil spring biasingly influencing said first latching member in an engaging rotational direction relative to the striker bar.

18. The latch assembly as described in claim 14, further comprising a translating cable extending to said linkage member, a remote end of said cable securing to a handle location associated with the vehicle seat.
